(19) United States
(12) Patent Application Publication
(10) Pub. No.: US 2012/0036745 A1
(43) Pub. Date: Feb. 16, 2012

(54) ELECTRONIC GREETING CARD INTEGRATED WITH PHYSICAL CARRIER AND GREETING CARD BROWSER

(76) Inventors: Hung-Wen CHEN, Taipei (TW); Shang-Wen Li, Taipei (TW); Hsu-Ping Feng, Taipei (TW); Ming-Lin Kao, Taipei (TW); Chih-Yueh Lin, Taipei (TW)

(21) Appl. No.: 12/856,452

(22) Filed: Aug. 13, 2010

(51) Int. Cl. G09F 1/00; H04B 7/00

(52) U.S. Cl. 40/124.01; 455/41.2

(57) ABSTRACT

An electronic greeting card integrated with a physical carrier is disclosed and includes: a first wireless communication circuit module for wirelessly transceiving a signal associated with data or a command; a first communication software module, when executed, establishing a communication link with an electronic apparatus with a greeting card browser via the first wireless communication circuit module; a greeting card software module for editing, browsing and archiving the digital content, and storing the digital content or the status information back to the electronic greeting card; at least one flash memory for storing programming codes respectively corresponding to the software modules and storing the digital content and status information; a processor for processing the data or command from the first wireless communication circuit module; and a physical carrier for carrying the first wireless communication circuit module, the flash memory and the processor.

### FIELD OF THE INVENTION

The present invention relates to an electronic greeting card, and more particularly, to an electronic greeting card integrated with a physical carrier.

### BACKGROUND OF THE INVENTION

Attributed to the prevalence of Internet, electronic greeting cards that are conveyed through Internet are extensively used by the modern people. Although electronic greeting cards have advantages of being easily operated and being able to be sent in mass, they are prone to leave card recipients an impression of getting blessings of low value.

Some conventional physical greeting electronic cards are equipped with an audio integrated circuit for playback and recording of audio greetings; however, such conventional greeting cards with audio yet cannot render more vivid greetings that involve animated pictures or video clips.

In view of the above, there is a need for a novel electronic greeting card without shortcomings associated with the prior art.

### SUMMARY OF THE INVENTION

Therefore, it is an object of the invention to provide an electronic greeting card integrated with a physical carrier, which allows a sender to enclose more diversified greeting content in the electric greeting card. Furthermore, the electronic greeting card can be delivered to a recipient by means of a postal office service or a courier service, to offer the recipient blessings and joy just like a real greeting card does.

To accomplish the above object, the present invention provides an electronic greeting card integrated with a physical carrier comprising: a first wireless communication circuit module for wirelessly transceiving a signal associated with data or a command; a first communication software module, when executed, establishing a link with an electronic apparatus with a greeting card browser via the first wireless communication circuit module; a greeting card software module, which is uploaded to and executed at the electronic apparatus as requested by the electronic apparatus, to edit, browse or archive the digital content of the greeting card, and store the digital content or the status information of the electronic greeting card back to the electronic greeting card; at least one flash memory for storing programming codes respectively corresponding to the first communication software module and the greeting card software module, and storing the status information and the digital content of the electronic greeting card; a processor for executing the first communication software module and processing the data or command from the first wireless communication circuit module; and a physical carrier for carrying the first wireless communication circuit module, the flash memory and the processor.

The present invention further provides a greeting card browser, which is applied with an electronic greeting card integrated with a physical carrier and is executed in an electronic apparatus having a second wireless communication circuit module which is capable of communicating with a first wireless communication circuit module of the electronic greeting card; the greeting card browser comprises: a second communication software module, when executed, establishing a link with the electronic greeting card via the second wireless communication circuit module; and a software module for loading greeting card programs, when executed, calling the second communication software module to at least load the greeting card software module of the electronic greeting card to the electronic apparatus, and optionally command the electronic apparatus to execute the greeting card software module after the greeting card software module has been loaded.

### BRIEF DESCRIPTION OF THE DRAWINGS

The present invention will become more readily apparent to those ordinarily skilled in the art after reviewing the following detailed description and accompanying drawings, in which:

FIG. 1 is a block diagram of an electronic greeting card integrated with a physical carrier according to an embodiment of the invention;

FIG. 2 is a schematic diagram of an environment in which an electronic greeting card is operated according to an embodiment of the invention;

FIG. 3 is a schematic diagram illustrating a communication link established between the greeting card browser and the electronic greeting card according to an embodiment of the invention;

FIG. 4 is a schematic diagram illustrating a communication link established for uploading the greeting card software module of the electronic greeting card to the electronic apparatus according to an embodiment of the invention;

FIG. 5 is an edit window at an electronic apparatus according to an embodiment of the invention;

FIG. 6 is a window showing archiving of the digital content of an electronic greeting card according to an embodiment of the invention;

FIG. 7 is a window at an electronic apparatus showing that the data is transmitted to and stored in an electronic greeting card according to an embodiment of the invention; and

FIG. 8 is a window at an electronic apparatus showing that an electronic greeting card is being browsed according to an embodiment of the invention.

### DETAILED DESCRIPTION OF THE PREFERRED EMBODIMENT

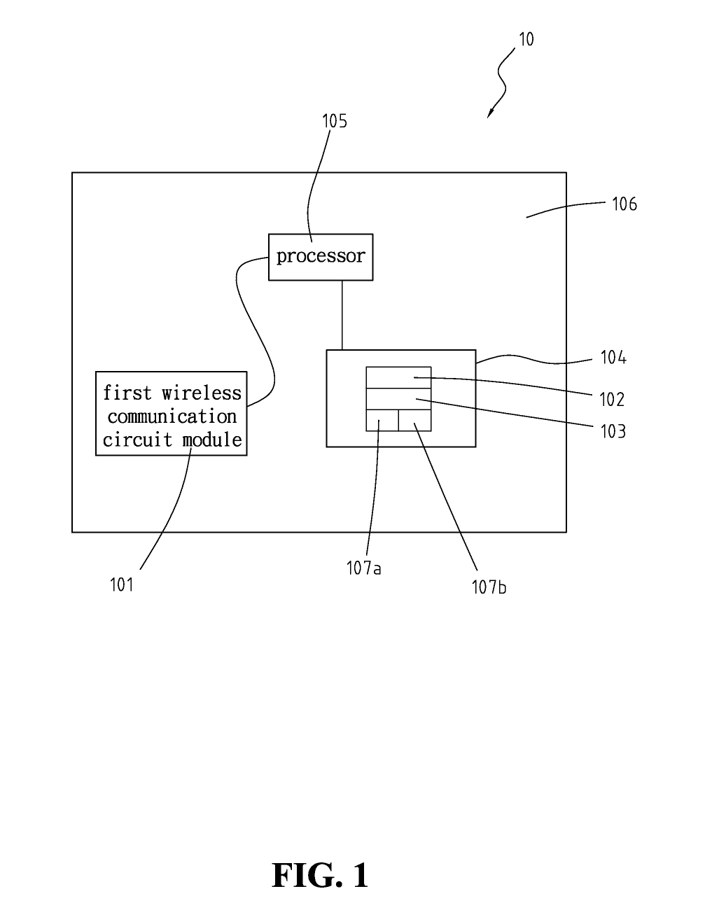

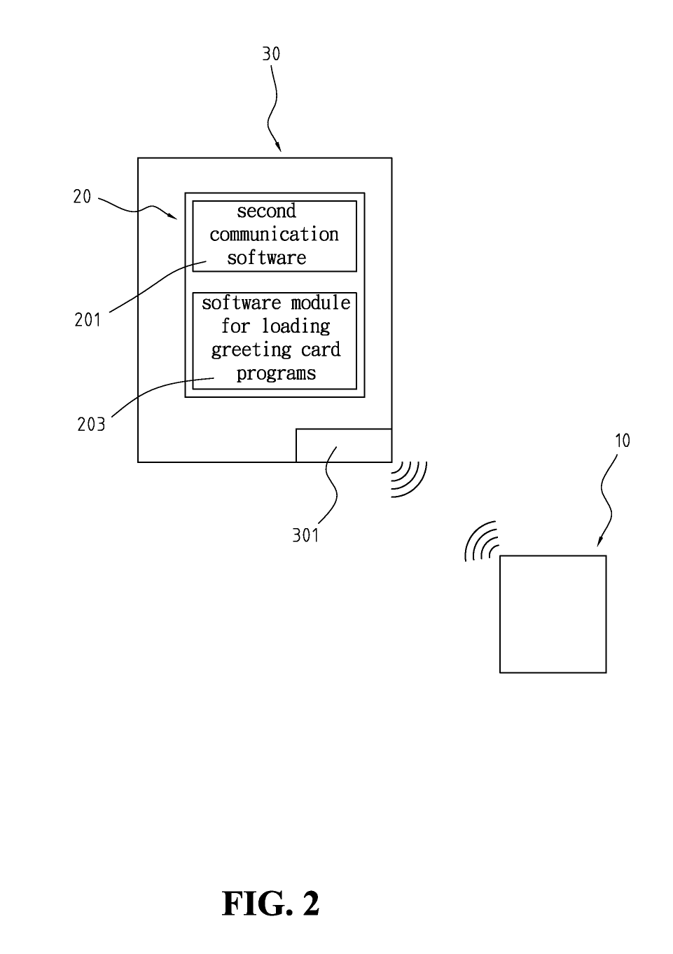

Referring to FIGS. 1 and 2, an electronic greeting card 10 integrated with a physical carrier may be a physical object selected from a card, a stationery, a bouquet, an animal model, a doll etc. At a sender's end, the electronic greeting card 10 is placed near an electronic apparatus 30 (e.g., a laptop computer, a desk-top computer or a mobile phone), and an electronic greeting card browser 20 according to the invention is then activated by the sender to upload a built-in greeting card software module 103 of the electronic greeting card 10 to the electronic apparatus 30. Next, the greeting card browser 20 commands the electronic apparatus 30 to execute the greeting card software module 103, so as to allow the sender to edit the greeting content of the electronic greeting card 10 and store the edited content in the electronic greeting card 10. For example, the greeting content includes animated pictures, texts, graphics, pictures, sounds and video clips. The electronic greeting card 10 is delivered to the recipient by a mail carrier, for example, a postal office service or a courier service to give the recipient blessings just like a real card does.

Upon receiving the electronic greeting card 10, it is placed near the electronic apparatus 30 (e.g., a laptop computer, a desk-top computer or a mobile phone) by the recipient to execute the greeting card browser 20, so that the greeting content combined with animated pictures, texts, graphics, pictures, sounds or video clips in the electronic greeting card 10 can be viewed by the recipients.

According to an embodiment of the invention, the electronic greeting card 10 comprises: a first wireless communication circuit module 101, a first communication software module 102, a greeting card software module 103, at least one flash memory 104, a processor 105 and a physical carrier 106, which are all to be described below. The first wireless communication circuit module 101 is for wirelessly transceiving a signal associated with data or a command, and may be selected from the conventional communication circuit modules, for example, a Bluetooth communication circuit module, an infrared communication circuit module, a radio frequency communication circuit module, a Wi-Fi communication circuit module, a Zigbee communication module etc. For illustration purposes, a conventional Bluetooth communication circuit module is used as the first wireless communication module 101 in an embodiment of the invention, however, the first wireless communication module 101 which can be used in the present invention is, of course, not limited thereto.

After being executed by the processor 105, the first communication software module 102 establishes a communication link with the electronic apparatus 30 with the greeting card browser 20 via the first wireless communication circuit module 101. The first communication software module 102 is directly realized by implementing Bluetooth Service Discovery Protocol (SDP) or Bluetooth Serial Port Profile (SPP) etc.

The greeting card software module 103 is uploaded to and executed at the electronic apparatus 30 as requested by the electronic apparatus 30. The greeting card software module 103 edits, browses, and archives the digital content 107a of the greeting card, e.g., the foregoing blessing content, and stores the digital content 107a or the status information 107b of the greeting card back to the electronic greeting card 10.

The flash memory 104 is used to store programming codes respectively corresponding to the first communication software module 102 and the greeting card software module 103, and store the digital content 107a or the greeting card status information 107b of the greeting card.

The first communication software module 102 and the greeting card software module 103 may be realized by firmware in the electronic apparatus 10.

The processor 105 executes the first communication software module 102 and processes the data or commands from the first wireless communication circuit module 101, and may be realized by a single-chip microprocessor. For example, the above data and commands from the first wireless communication circuit module 101 are Bluetooth SDP or Bluetooth SPP packets, or packets of other Bluetooth protocols.

The physical carrier 106 is, for example, a card, a stationery, a bouquet, an animal model, a doll, or other physical objects. The physical carrier 106 carries physical elements, including units composing the wireless communication circuit module 101, the flash memory 104 and the processor 105.

The greeting card browser 20 according to an embodiment of the invention is to be described below. The greeting card browser 20, downloadable from Internet or stored in a recording medium, such as CD packaged and enclosed with the electronic greeting card 10, may be realized by software and is applied in conjunction with the electronic greeting card 10. Further, the greeting card browser 20 is executed by the electronic apparatus 30. The electronic apparatus 30 is equipped with (or connected with) a second wireless communication circuit module 301 capable of communicating with the first wireless communication circuit module 101 of the electronic greeting card 10. For example, the second wireless communication circuit module 301 is a USB Bluetooth transceiver. The greeting card browser 20 comprises a second communication software module 201 and a software module for loading greeting card programs 203.

The second communication software module 201 is executed by a central processing unit (CPU) of the electronic apparatus 30 to establish a communication link with the electronic greeting card 10 via the second wireless communication circuit module 301. Taking the above USB Bluetooth transceiver for example, since the second communication software module 201 is a medium between the software module for loading greeting card programs 203 and the USB Bluetooth transceiver, the second communication software module 201 may be realized by implementing the Bluetooth SDP, Bluetooth SPP technologies, or even transport layer protocols such as the Transmission Control Protocol (TCP).

After the software module for loading greeting card programs 203 is executed by the CPU of the electronic apparatus 30, the second communication software module 201 is called to at least load the greeting card software module 103 of the electronic greeting card 10 into the electronic apparatus 30, and optionally command the CPU of the electronic apparatus 30 to execute the greeting card software module 103 after the greeting card software module 103 has been loaded. The software module for loading greeting card programs 203 may be a software module developed by Adobe ActionScript, Microsoft Silverlight, or HTML5 to realize codes of the software module for loading greeting card programs 203.

Further, since the second communication software module 201 is a medium between the greeting card software module 103 and the USB Bluetooth transceiver, the second communication software module 201 may be realized by implementing the Bluetooth SDP, Bluetooth SPP technologies, or even transport layer protocols such as the TCP.

A person skilled in the art would easily appreciate that development tools including the Adobe™ ActionScript™, Microsoft™ Silverlight™ and HTML5™ lack the capability of directly communicating through the Bluetooth. It is to be noted that, although the software module for loading greeting card programs 203 and greeting card software module 103 are developed by the development tools including the Adobe™ ActionScript™, Microsoft™ Silverlight™ and HTML5™, the second communication software module 201 comprising a gateway functionality is capable of communicating through the Bluetooth.

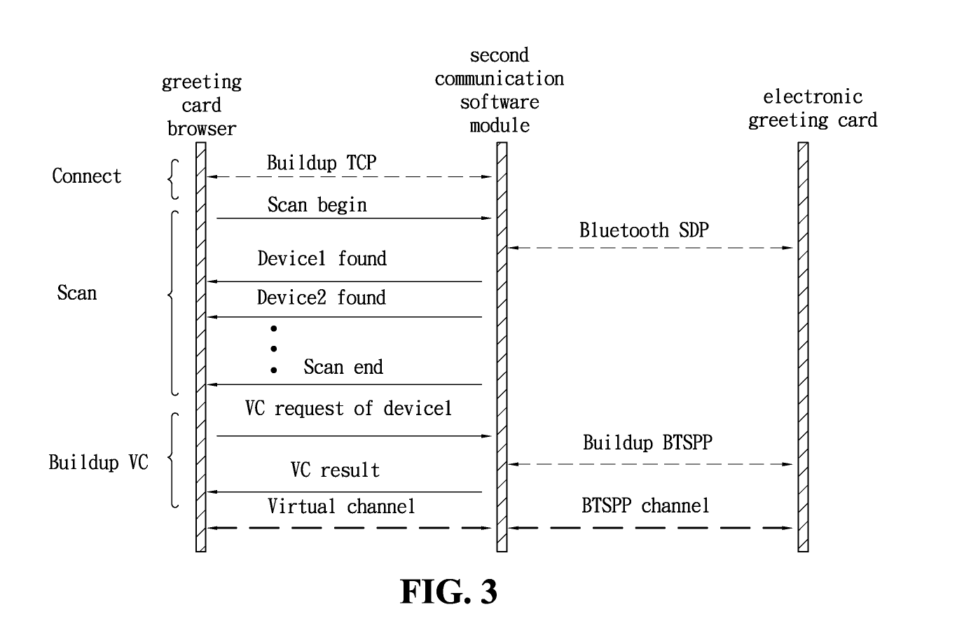

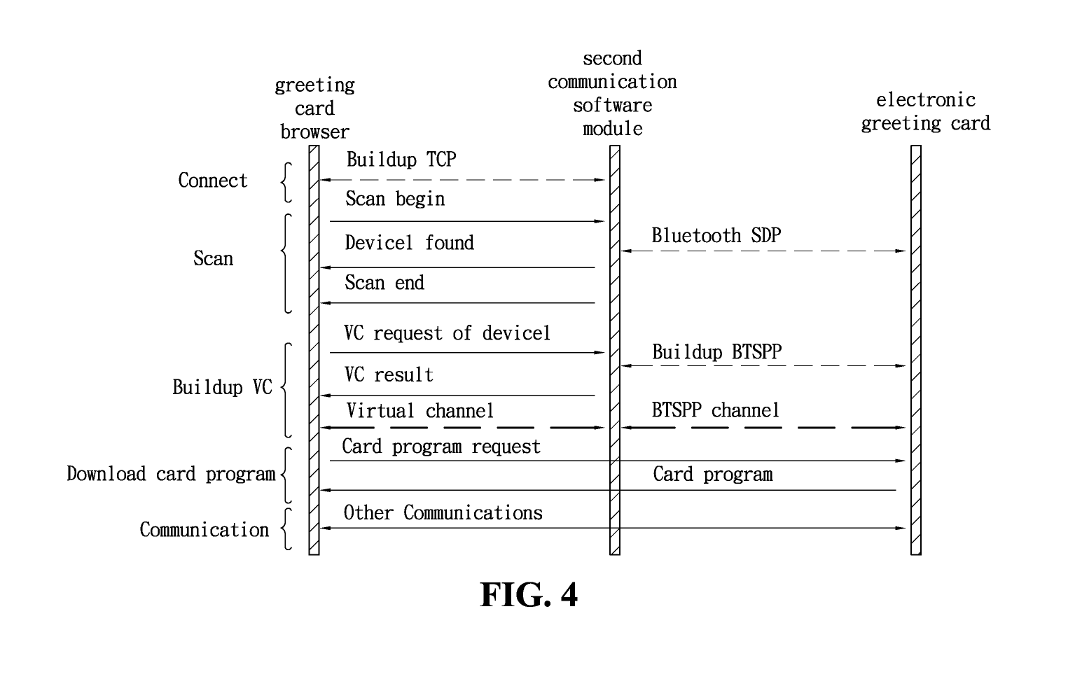

FIG. 3 shows a schematic diagram illustrating a communication link established between the greeting card browser and the electronic greeting card according to an embodiment of the invention. The electronic greeting card 10 is placed within a wireless communication range of the electronic apparatus 30 by a sender or a recipient. The greeting card browser 20 is then executed to search for any electronic greeting card 10 within the vicinity to establish a communication link with any identified electronic greeting card 10. FIG. 4 shows a schematic diagram illustrating a communication link established for uploading the greeting card software module of the electronic greeting card to the electronic apparatus. When the communication link is established between the electronic apparatus 30 and the electronic greeting card 10, the software module for loading greeting card programs 203 uploads the greeting card software module 103 of the electronic greeting card 10 to the electronic apparatus 30.

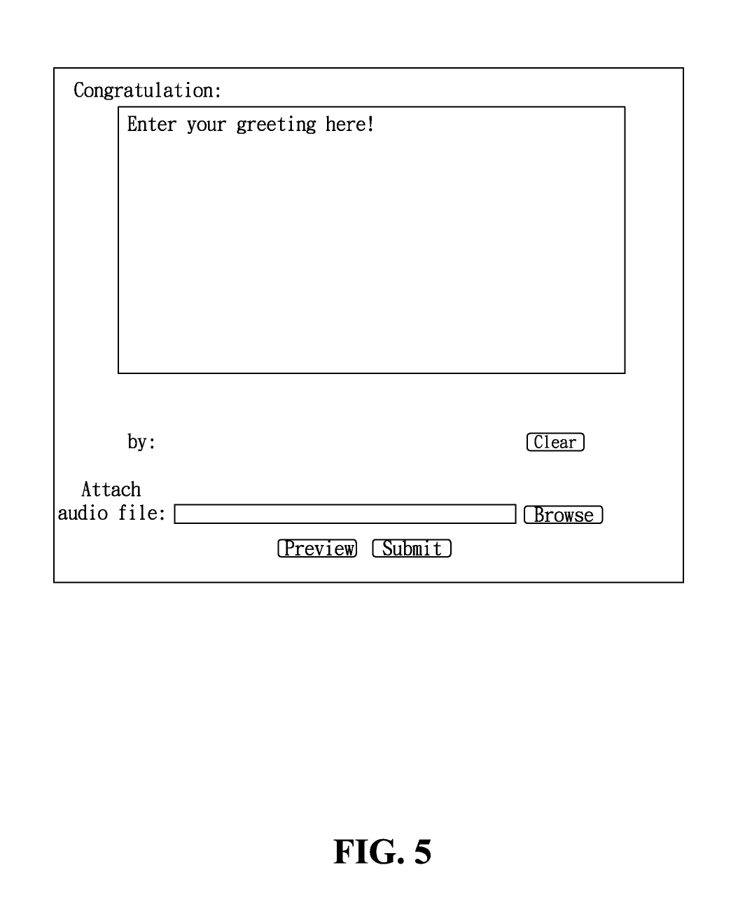

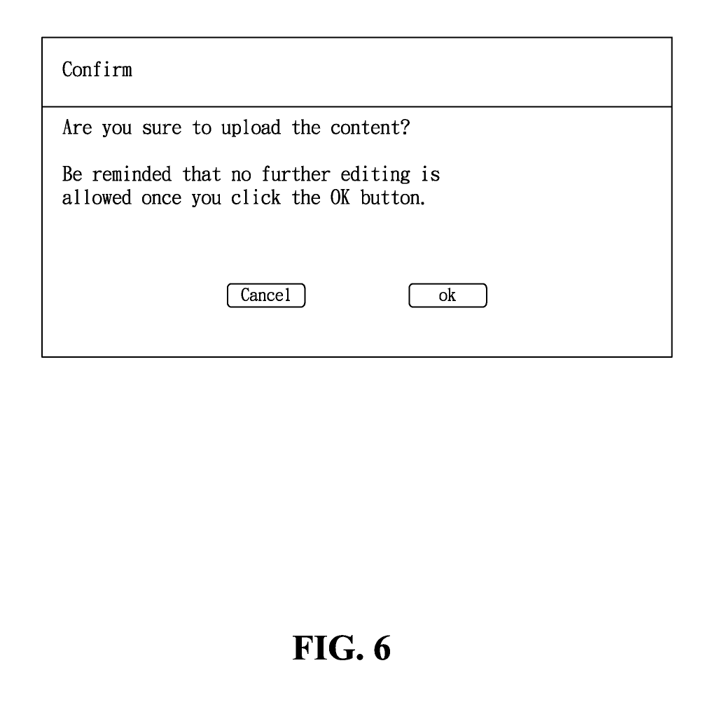

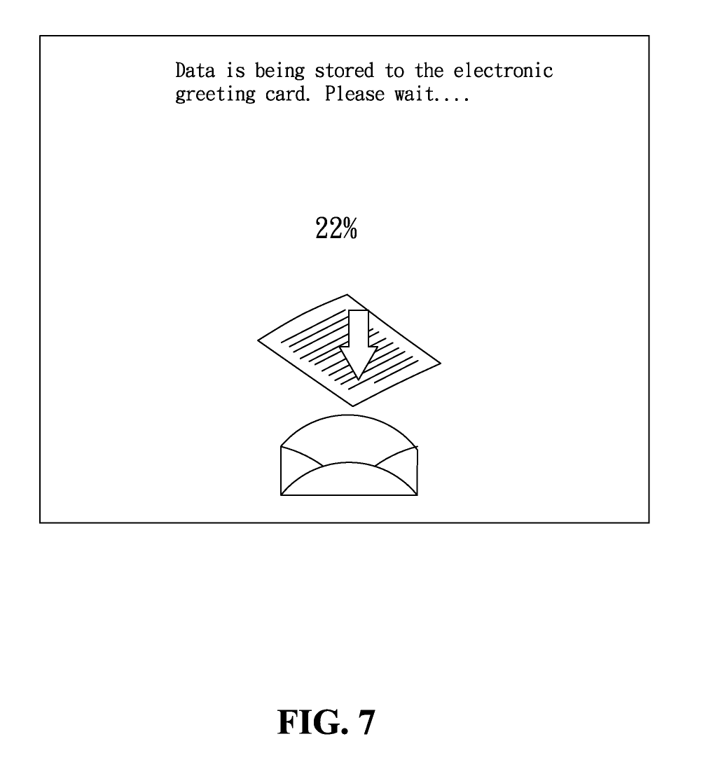

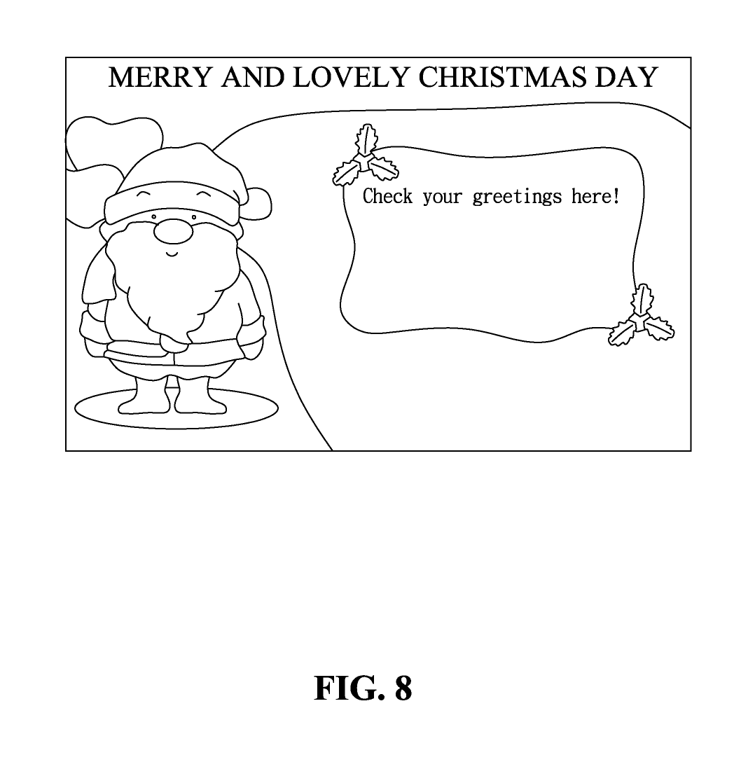

When the greeting card software module 103 is uploaded by the sender or the recipient, the electronic apparatus 30 then executes the greeting card software module 103. Accordingly, the sender is allowed to edit or modify greeting card digital content 107a of the electronic greeting card 10, as illustrated in FIG. 5 showing an edit window of the electronic apparatus according to an embodiment of the invention. Alternatively, the sender is also allowed to archive the digital content 107a of the electronic greeting card 10 through the greeting card software module 103, and the archived digital content 107a of the electronic greeting card 10 then cannot be further modified. FIG. 6 shows a window of archiving the digital content 107a of the electronic greeting card 10, and FIG. 7 shows a window of transmitting and storing data to the electronic greeting card 10. When the electronic greeting card 10 is received by the recipient, the recipient uploads the greeting card software module 103 of the electronic greeting card 10 via the software module for loading greeting card programs 203 to the electronic apparatus 30, and executes the greeting card software module 103 to view the digital content 107a of the electronic greeting card 10, as shown in FIG. 8.

The greeting card software module 103 may implement development tools, e.g., Adobe™ ActionScript™, Microsoft™ Silverlight™, or HTML5™, to realize codes of the software module for loading a greeting card program 203.

Through the greeting card software module 103, greeting card status information 107b of the electronic greeting card 10 may also be uploaded to the electronic apparatus 30 to determine whether the electronic greeting card 10 is archived. Alternatively, the greeting card status information 107b is stored back to the electronic greeting card 10 to proceed with archiving of the electronic greeting card 10.

With the electronic greeting card integrated with a physical carrier of the invention, a sender is allowed to enclose more diversified greeting content in the greeting card so that a recipient is rendered with blessings and joy of a real greeting card. Further, the electronic greeting card comprising a physical carrier of the invention, by adopting a gateway functionality, offers a distinguished advantage of realizing transmissions of development tools including Adobe™ ActionScript™, Microsoft™ Silverlight™, or HTML5™ through the Bluetooth.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An electronic greeting card integrated with a physical carrier, comprising:
a first wireless communication circuit module, for wirelessly transceiving a signal associated with data or a command;
a first communication software module, when executed, establishing a communication link with an electronic apparatus with a greeting card browser via the first wireless communication circuit module;
a greeting card software module, which is uploaded to and executed at the electronic apparatus as requested by the electronic apparatus, to edit, browse or archive the digital content of the electronic greeting card, and store the digital content or the status information of the electronic greeting card back to the electronic greeting card;
at least one flash memory, for storing programming codes respectively corresponding to the first communication software module and the greeting card software module, and storing the status information and the digital content of the electronic greeting card;
a processor, for executing the first communication software module, and processing the data or command from the first wireless communication circuit module; and
a physical carrier, for carrying the first wireless communication circuit module, the flash memory and the processor.

2. The electronic greeting card integrated with a physical carrier as claimed in claim 1, wherein the physical carrier is any one selected from a card, a stationery, a bouquet, an animal model, a doll and other physical objects.

3. The electronic greeting card integrated with a physical carrier as claimed in claim 1, wherein the first wireless communication circuit module is selected from a Bluetooth communication circuit module, an infrared communication circuit module, a radio frequency communication circuit module, a Wi-Fi communication circuit module, or a Zigbee communication module.

4. The electronic greeting card integrated with a physical carrier as claimed in claim 1, wherein the greeting card software module is a software module developed by a development tool selected from Adobe™ ActionScript™, Microsoft™ Silverlight™, or HTML5™.

5. A greeting card browser applied with the electronic greeting card integrated with a physical carrier as claimed in claim 1, the greeting card browser being executed in an electronic apparatus having a second wireless communication circuit module which is capable of communicating with the first wireless communication circuit module of the electronic greeting card; the greeting card browser comprising:
a second communication software module, when executed, establishing a communication link with the electronic greeting card via the second wireless communication circuit module;
a software module for loading greeting card programs, when executed, calling the second communication software module to at least load the greeting card software module of the electronic greeting card to the electronic apparatus, and optionally command the electronic apparatus to execute the greeting card software module after the greeting card software module has been loaded.

6. The greeting card browser as claimed in claim 5, wherein the software module for loading greeting card programs is developed by a development tool selected from Adobe ActionScript™, Microsoft™ Silverlight™, or HTML5™.

7. The greeting card browser as claimed in claim 5, wherein the software module for loading greeting card programs, when further executed, calls the second communication software module to load the digital content of the electronic greeting card to the electronic apparatus, and command the electronic apparatus to play the digital content of the electronic greeting card.

8. The greeting card browser as claimed in claim 5, wherein the software module for loading greeting card programs, when further executed, calls the second communication software module to load the status information of the electronic greeting card to the electronic apparatus, and command the electronic apparatus to display the status information of the electronic greeting card.

9. The greeting card browser as claimed in claim 5, wherein the greeting card browser is programming codes downloadable from Internet or programming codes stored in a recording medium.

10. The greeting card browser as claimed in claim 5, wherein the greeting card software module, when executed by the electronic apparatus, is capable of calling the second communication software module.

11. The greeting card browser as claimed in claim 5, wherein the electronic apparatus is selected from a laptop computer, a desktop computer, a mobile phone or a television.

12. An electronic apparatus applied in conjunction with the electronic greeting card integrated with a physical carrier as claimed in claim 1, comprising:
a second wireless communication circuit module, for communicating with the first wireless communication circuit module of the electronic greeting card;
a greeting card browser executed by the electronic apparatus, including:
a second communication software module, when executed, establishing a communication link with the electronic greeting card via the second wireless communication circuit module;
a software module for loading greeting card programs, when executed, calling the second communication software module to at least load the greeting card software module of the electronic greeting card to the electronic apparatus, and optionally command the electronic apparatus to execute the greeting card software module after the greeting card software module has been loaded.

13. The electronic apparatus as claimed in claim 12, wherein the software module for loading a greeting card program is a software module developed by Adobe™ ActionScript™, Microsoft™ Silverlight™, or HTML5™.

14. The electronic apparatus as claimed in claim 12, wherein the software module for loading greeting card programs, when further executed, calls the second communication software module to load the digital content of the electronic greeting card to the electronic apparatus and command the electronic apparatus to play the digital content of the electronic greeting card.

15. The electronic apparatus as claimed in claim 12, wherein the software module for loading greeting card programs, when further executed, calls the second communication software module to load the status information of the electronic greeting card to the electronic apparatus and command the electronic apparatus to display the status information of the electronic greeting card.

16. The electronic apparatus as claimed in claim 12, wherein the greeting card browser is programming codes downloadable from Internet or programming codes stored in a recording medium.

17. The electronic apparatus as claimed in claim 12, wherein the greeting card software module, when executed by the electronic apparatus, is capable of calling the second communication software module.

18. The electronic apparatus as claimed in claim 12, wherein the electronic apparatus is selected from a laptop computer, a desktop computer, a mobile phone or a television.
